(19) United States
(12) Patent Application Publication
(10) Pub. No.: US 2023/0376226 A1
(43) Pub. Date: Nov. 23, 2023

(54) STORAGE BLOCK MANAGEMENT INFORMATION SYNCHRONOUS RECORDING METHOD AND SYSTEM, AND TERMINAL AND STORAGE MEDIUM

(71) Applicant: INSPUR SUZHOU INTELLIGENT TECHNOLOGY CO., LTD., Suzhou, Jiangsu (CN)

(72) Inventors: Min WANG, Suzhou, Jiangsu (CN); Chuang ZHANG, Suzhou, Jiangsu (CN); Zhixin REN, Suzhou, Jiangsu (CN)

(21) Appl. No.: 18/029,066

(22) PCT Filed: Nov. 29, 2021
(86) PCT No.: PCT/CN2021/134141

§ 371 Date: Mar. 28, 2023

(30) Foreign Application Priority Data
Jan. 22, 2021 (CN) 202110091052.4

(51) Int. Cl. G06F 3/06

(52) U.S. Cl. CPC G06F 3/064; G06F 3/065; G06F 3/0604; G06F 3/0679

(57) ABSTRACT

Provided are a storage block management information synchronous recording method and system, and a terminal and a storage medium. The method comprises: screening, from all good blocks, two blocks having the greatest difference, and taking the two blocks as a master block and a slave block; setting the number of synchronous recording interval pages of the master block and the slave block; and synchronously writing management information to the master block and the slave block according to the number of interval pages. According to the present application, by using an information recording method of a master-slave block interval alternating method, two block intervals are used and various abnormal situations are handled synchronously, such that where data of one part is lost, a copy can be obtained from the other party, thereby ensuring that an NAND operation system does not break down due to the frequent occurrence of information errors.

### CROSS-REFERENCE TO RELATED APPLICATION

The present disclosure claims the priority of the Chinese patent application filed on Jan. 22, 2021 before the China National Intellectual Property Administration with the application number of 202110091052.4 and the title of “STORAGE BLOCK MANAGEMENT INFORMATION SYNCHRONOUS RECORDING METHOD AND SYSTEM, AND TERMINAL AND STORAGE MEDIUM”, which is incorporated herein in its entirety by reference.

### FIELD

The present disclosure relates to the field of storage technology, in particular to a method, a system, a terminal, and a nonvolatile storage medium, for synchronously recording management information of storage block.

### BACKGROUND

NAND Flashes are nonvolatile memories that are widely used in various storage situations at present. An ideal flash memory should meet characteristics of small size, fast operation speed, low programming voltage, strong anti-erase ability, long retention time, and so on.

A NAND Flash consists of blocks, and a block consists of pages, a function of which is to store data. Due to record information for load balancing, bad-block management, and so on, may be generated in using of a NAND flash, it is necessary to select several blocks from the entire NAND flash, to be used as management blocks.

However, during a use of the management block, situations of recording error of information, and so on, may occur, which is not allowed to occur, because once a recording error of management information occurs, it may lead to a NAND flash to be confused in using, and even to be scrapped. How to effectively record information to avoid an occurrence of error as much as possible, is a very important content of research.

Two schemes below are commonly-used recording methods:

A recording method of single-block:

A single block having a low error rate, is selected from an entire repository of block of a NAND flash, as a management block, and writing is started from page 0 and goes down sequentially. After the entire block is full for writing, erasing is performed on the blocked, and then a next round of recording is performed thereon. An inventor of the disclosure realizes that, in this method, when an error occurs during the recording of the single block or the single block becomes a bad block, recorded information will be lost.

A recording method of synchronous of a master block and a slave block:

Two blocks having a low error rate, are selected from an entire repository of block of a NAND flash, as management blocks (respectively to be a master block and a slave block), and a same content is sequentially written thereinto from page 0, to prevent an error occurring in recording information in one block, that is, the information thereof may be restored from another block.

### SUMMARY

In a first aspect, in some embodiments, the present disclosure provides a method for synchronously recording management information of storage block, including:
selecting two blocks, difference between which is the largest, from every good-working block, as a master block and a slave block;
setting a number of pages of an interval at which the master block and the slave block synchronously record; and
synchronously writing management information into the master block and the slave block at the interval of the number of pages.

In some embodiments, the selecting two blocks, difference between which is the largest, from every good-working block, as a master block and a slave block, includes:
selecting the good-working blocks from every storage block;
sorting every good-working block by numbers of block;
selecting a top-positioned one of the sorted good-working blocks, as the master block; and
selecting candidate blocks whose parity is different from that of the master block, from the good-working blocks, and selecting a last-numbered one of the candidate blocks, as the slave block.

In some embodiments, the setting a number of pages of an interval at which the master block and the slave block synchronously record includes:
setting the number of pages of the interval to be a half of a total number of pages.

In some embodiments, the synchronously writing management information into the master block and the slave block at the interval of the number of pages, includes:
in response to writing on a first page of a first half block of the master block, selecting a corresponding page of the slave block according to the number of pages of the interval, and synchronously writing the management information on the corresponding page of a second half block of the slave block;
before synchronously writing the management information into the slave block, writing filling data on every page before the corresponding page of the second half block, for filling; and
in response to writing on a last page of the first half block of the master block, erasing the slave block by the filling data first, and then synchronously writing the master block and the slave block.

In some embodiments, the method further includes:
finding a last page that is not entirely filled with the filing data, in the master block, reading data as the management information, and outputting the data; and
in response to that finding data in the master block fails, finding a last page that is not entirely filled with the filing data, in the slave block, reading data as the management information, and outputting the data.

In some embodiments, the method further includes:
in response to that a power failure occurs in synchronously recording, and that data in the master block is correct, copying the data in the master block to the corresponding page of the slave block; and
in response to that a power failure occurs in synchronously recording, and that data in the master block is incorrect, respectively drawing previous pages of the master block and the slave block, with respect to the currently-recording pages of the master block and the slave block when the power failure occurs, for proofreading, then removing the data in the master block, and then synchronously copying data in the slave block to the master block.

In a second aspect, the present disclosure provides a system for synchronously recording management information of storage block, including:
a master-slave-selecting unit, configured to select two blocks, difference between which is the largest, from every good-working block, as a master block and a slave block;
an interval-setting unit, configured to set a number of pages of an interval at which the master block and the slave block synchronously record; and
a synchronously-writing unit, configured to synchronously write management information into the master block and the slave block at the interval of the number of pages.

In some embodiments, the master-slave-selecting unit includes:
a good-working-block-selecting module, configured to select the good-working blocks from every storage block;
a number-sorting module, configured to sort every good-working block by numbers of block;
a master-block-determining module, configured to select a top-positioned one of the sorted good-working blocks, as the master block; and
a slave-block-determining module, configured to select candidate blocks whose parity is different from that of the master block, from the good-working blocks, and select a last-numbered one of the candidate blocks, as the slave block.

In a third aspect, the present disclosure provides a terminal, including: a memory and one or more processors, wherein computer-readable instructions are stored in the memory, and when the computer-readable instructions are executed by the one or more processors, the one or more processors perform the steps of any of the above methods for synchronously recording management information of storage block.

In a fourth aspect, the present disclosure provides one or more nonvolatile computer-readable storage media, storing computer-readable instructions, wherein, when the computer-readable instructions are executed by one or more processors, the one or more processors perform the steps of any of the above methods for synchronously recording management information of storage block.

Details of one or more embodiments of the disclosure will be provided in the following drawings and description. Other features and advantages of the disclosure will become apparent in the specification, drawings and the claims.

### BRIEF DESCRIPTION OF THE DRAWINGS

In order to more clearly illustrate the technical solutions in the embodiments of the disclosure or in the prior art, the following will briefly introduce the drawings needed to be used in illustrating the embodiments or the prior art. Apparently, for those ordinary skilled in the field, they may further obtain other drawings according to the provided drawings without paying creative labor.

FIG. 1 is a schematic flow chart of a method for synchronously recording management information of storage block in one or more embodiments.

FIG. 2 is a schematic block diagram of a system for synchronously recording management information of storage block in one or more embodiments.

FIG. 3 is a schematic diagram of a structure of a terminal provided in one or more embodiments.

### DETAILED DESCRIPTION OF THE EMBODIMENTS

In order to make those in the technical field to better understand technical solutions in the disclosure, the following will clearly and completely describe the technical solutions in the embodiments of the disclosure in combination with the drawings in the embodiments of the disclosure. Apparently, the described embodiments are just a part of the embodiments of the disclosure, not all of the embodiments. Based on the embodiments in the present disclosure, all other embodiments obtained by those ordinary skilled in the art without paying creative work, should fall within the scope of protection of the present disclosure.

The inventor of the disclosure realizes that, in designing the NAND flash using the recording method of synchronous of a master block and a slave block, there may be a situation that certain specific pages (for example, page 0, page 255, and so on) have a high error rate, therefore, even if there is a backup block that may modify information with error, of the master block, it is inevitable that the two blocks will make errors on a certain specific page, such that accurate information may not be restored. Aiming at the above shortcomings of the prior art, the present disclosure provides a method, a system, a terminal, and a nonvolatile storage medium, for synchronously recording management information of storage block, to solve the above technical problems.

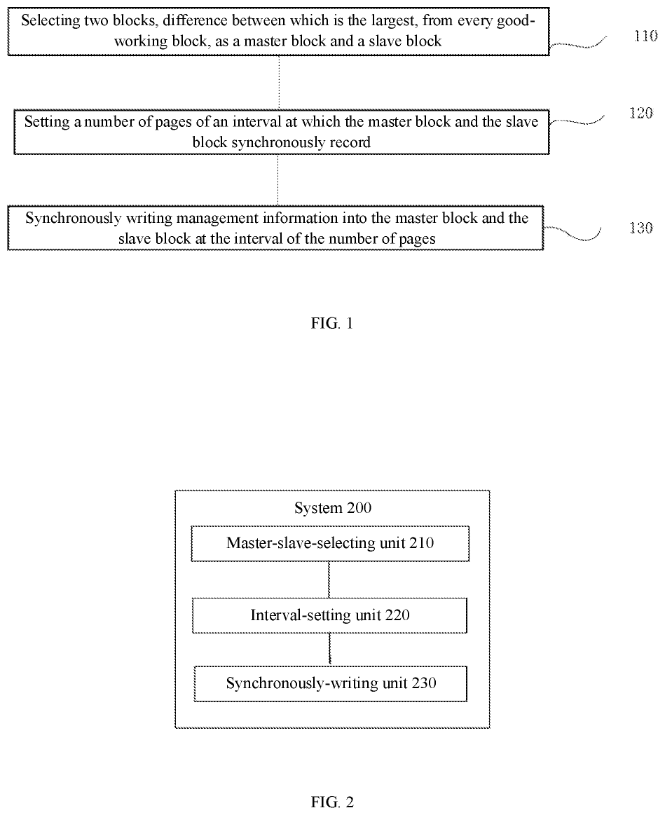

FIG. 1 is a schematic flow chart of a method according to an embodiment of the present disclosure, wherein an executing body of the method of FIG. 1 may be a system for synchronously recording management information of storage block.

As shown in FIG. 1, the method includes:

Step 110, selecting two blocks, difference between which is the largest, from every good-working block, as a master block and a slave block.

Step 120, setting a number of pages of an interval at which the master block and the slave block synchronously record.

Step 130, synchronously writing management information into the master block and the slave block at the interval of the number of pages.

Concretely, the method for synchronously recording management information of storage block includes:
S1. selecting two blocks, difference between which is the largest, from every good-working block, as a master block and a slave block.

There are several principles for selecting the blocks:
(1) The selected two blocks shall be the good-working blocks.
(2) Considering that an error distribution shown by odd blocks is different from that shown by even blocks, it shall be ensured that a parity of a number of the master block is different from that of the slave block.
(3) In an entire block distribution, the larger a difference between the number of the master block and the number of the slave block, the better. For example, if a block of No. 2 of the distribution is selected as the master block, a block of a number close to a tail of the distribution shall be selected as the slave block.
S2. setting a number of pages of an interval at which the master block and the slave block synchronously record.

An information error may occur on the same page of the master block and the slave block. This disclosure makes the master block and the slave block record at a certain interval of a number of pages, for example, makes a content recorded on page 0 of the master block is the same as that recorded on page 10 of the slave block. In order to know how much the interval should be selected, taking that a single block has N pages, as an example, a jumping interval selects N/2.
S3. synchronously writing management information into the master block and the slave block at the interval of the number of pages.

When the master block records information on a page of a first half block, the slave block records information on a page of a second half block, and a distance of N/2 is kept between numbers of pages for synchronously recording, of the two blocks. When the master block records information on a page of a second half block, the slave block records information on a page of a first half block. That is:

Information written on page X of the master block=information written on page (X+N/2) of the slave block,

where X≤(N/2).

Information written on page X of the slave block=information written on page (X−N/2) of the master block,

where N>X>(N/2).

It should be noticed that, when the master block just writes page N/2, the slave block just writes the last page, that is, page N. When a next piece of information needs to be recorded, the master block writes page N/2+1, but the slave block is already full for writing. At this time, it is necessary to erase the slave block first, and then write page 1 of the slave block. In a same principle, when the slave block writes page N/2+1, it needs to erase the master block first, and then writes page 1 of the master block.

One of attributes of the block is that writing may not be performed in the block in a jumping manner. Therefore, in order to make the master block uses the page N/2+1, it is necessary to perform a data-filling operation on first N/2 pages of the slave block. Since data in a first half of the block itself is worthless, writing may be performed arbitrarily on the first half of the block, if only it is ensured that it is not in a state of being erased. Therefore, 1 may be written into the entire first half of the block, or 0 may be written into the entire first half of the block, which is not important, but such a step is necessary. 1 is selected as every filled data in the embodiments.
S4. reading a correct record.

Following situations may occur in reading data:
(1) Data may directly read in the master block.

In reading the master block, a last page that is not entirely 1, is found, and then the data is directly read.
(2) An error is in the master block, and data is fetched from the slave block.

Data is read in the master block first: a last page that is not entirely 1, is found, and the data is read. If there is an error in the master block, a last page that is not entirely 1, of the slave block, is visited, for fetching the data.
(3) A situation of power failure during recording, occurs.

If the master block completes recording and the slave block has not yet recorded, there are two cases where data in the master block is correct or incorrect.

Case 1: the data of the master block is correct.

The correct data of the master block is copied to a corresponding page of the slave block, to ensure the two blocks to be synchronized.

Case 2: the data of the master block is incorrect.

If the data of the master block is incorrect and the slave block has no related record, the data in the recording at this time will be lost. For example, the master block currently has recorded on page X, and the slave block has recorded on page (X+N/2−1), so the master block currently needs to perform following steps:
Step 1: data is read on page (X−1) of the master block, and together with the page (X+N/2−1) of the slave block, to obtain the correct data (at this time, just the correct data on a previous page may be fetched).
Step 2: Information is synchronized, which refers to uniformizing the information of the two blocks. Information in the master block is entirely removed (the page may not be erased separately, so the entire block shall be erased), and then information in the slave block is synchronously copied to the master block.

The embodiment is illustrated in detail, by taking an L06B NAND, as an example. The L06B NAND has 512 blocks, and a single block has 256 pages.

The numbers of the master block and the slave block are selected. In view of the above principles, a block 2 is selected as the master block, and a block 511 is selected as the slave block. After checking, the two blocks are determined to be the good-working blocks. For the above blocks, N=256, then a step size of an interval is selected as N/2, that is, 128, and then numbers of page are from page 1 to page 256. When the master block records on the first 128 pages, the slave block records on the second 128 pages.

Data filling is performed, to entirely write 0 into the first 128 pages of the slave block.

Data is written into the two blocks, in an order as shown in a following table:

| Numbers of the master block | Numbers of the slave block |
|---|---|
| 1 | 129 |
| 2 | 130 |
| 3 | 131 |
| . . . | . . . |
| 128 | 256 |

Following situations is handled:
1) Recording is completed on first two pages. Data reading is performed, and a correct record may be obtained on page 2 of the master block.
2) Recording is completed on first two pages. Data reading is performed, and if page 2 of the master block returns an error, a page 130 of the slave block is visited for reading a correct record.
3) Recording is completed on page 3 of the master block, and a power failure occurs. After a power restoring, a correct data may be obtained on the page 3 of the master block, then information on the page 3 of the master block is synchronized to page 131 of the slave block, so as to synchronize the two blocks.
4) Recording is completed on page 4 of the master block, and a power failure occurs. After a power restoring, if data on the page 4 of the master block has an error, the master block is entirely erased, and every valid record (on pages 129 to 131) of the slave block are copied to the master block, to make page 1 to page 3 valid of the master block, so as to ensure the two blocks to be synchronized.

Beneficial effects of the disclosure lie in follows:

The method for synchronously recording management information of storage block, a system, a terminal and a storage medium thereof, provided by the present disclosure, use the master block and the slave block, to alternatively record information at an interval, use the two blocks at the interval and to be synchronized, to handle various abnormal situations, such that, in a condition that data is lost on one side, the data may be copied from the other side, ensuring that a running system of NAND flash will not be paralyzed due to frequent occurrence of information errors.

Further, a design principle of the disclosure is reliable, and a structure thereof is simple, so the disclosure has a very wide application prospect.

As shown in FIG. 2, the system 200 includes:

A master-slave-selecting unit 210, configured to select two blocks, difference between which is the largest, from every good-working block, as a master block and a slave block.

An interval-setting unit 220, configured to set a number of pages of an interval at which the master block and the slave block synchronously record.

A synchronously-writing unit 230, configured to synchronously write management information into the master block and the slave block at the interval of the number of pages.

For example, as an embodiment of the present disclosure, the master-slave-selecting unit includes:

A good-working-block-selecting module, configured to select the good-working blocks from every storage block.

A number-sorting module, configured to sort every good-working block by numbers of block.

A master-block-determining module, configured to select a top-positioned one of the sorted good-working blocks, as the master block.

A slave-block-determining module, configured to select candidate blocks whose parity is different from that of the master block, from the good-working blocks, and select a last-numbered one of the candidate blocks, as the slave block.

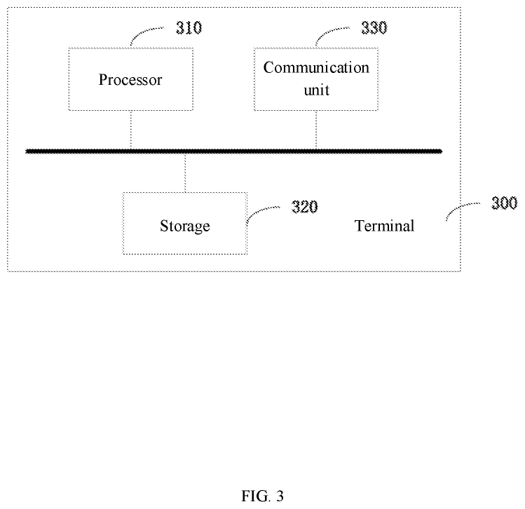

FIG. 3 is a schematic diagram of a structure of a terminal 300 provided by an embodiment of the disclosure, and the terminal 300 may be used to perform the method for synchronously recording management information of storage block provided by the embodiments of the present disclosure.

Among them, the terminal 300 may include: a processor 310, a storage 320, and a communication unit 330. These components communicate to each other through one or more buses. Those skilled in the art may understand that a structure of a server shown in the drawings does not constitute a limitation to the present disclosure. It may be either a bus-formed structure or a star-formed structure, and may include more or fewer components than shown, or be combined with certain components, or have different arrangements of component, as well.

Among them, the storage 320 may be used to store executable instructions for the processor 310. The storage 320 may be implemented by any type of volatile or nonvolatile storage terminal or a combination thereof, for example, a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a disk or optical disc, or the combination thereof. When the executable instructions in the storage 320 are executed by the processor 310, the terminal 300 is enabled to perform a part of the steps or every step in the above method embodiments.

The processor 310 serves as a control center of the storage terminal, connects various parts of an entire electronic terminal using various interfaces and lines, and performs various functions and/or processes data of the electronic terminal, by running or executing software programs and/or modules stored in the storage 320, as well as invoking data stored in the memory. The processor may be composed of integrated circuits (ICs), for example, may be composed of a package of a singly IC, or may be composed of a package connected with a plurality of ICs with the same or different functions. For example, the processor 310 may include just a central processing unit (CPU). In the embodiments of the present disclosure, the CPU may have a single arithmetic core or may include a plurality of arithmetic cores.

A communication unit 330 is used for establishing a communication channel so that the storage terminal may communicate with other terminals, receiving user data sent by other terminals, or sending user data to other terminals.

The present disclosure further provides a nonvolatile computer storage medium, wherein the nonvolatile computer storage medium may store a program, and when the program is executed, the program may include a part of the steps or every step in the respective embodiments provided by the present disclosure. The storage media may be a magnetic disk, an optical disk, a read-only memory (ROM), or a random-access memory (RAM), and so on.

Therefore, the present disclosure uses the master block and the slave block, to alternatively record information at an interval, use the two blocks at the interval and to be synchronized, to handle various abnormal situations, such that, in a condition that data is lost on one side, the data may be copied from the other side, ensuring that a running system of NAND flash will not be paralyzed due to frequent occurrence of information errors. Technical effects that the embodiments may realize, may be referred to the above description, which will not be repeated here.

Those skilled in the art may clearly understand that the technology in the embodiments of the present disclosure may be implemented by means of software plus a necessary general-purpose hardware platform. Based on such understanding, essentially, the technical solutions in the embodiments of the present disclosure or a contributed part for related technology may be embodied in form of a software product. The computer software product is stored in a nonvolatile storage medium, that is, various media that may store program code, for example, a USB flash drive, a removable hard disk, a read-only memory (ROM), a random-access memory (RAM), a magnetic disk, or an optical disk, and so on. The medium includes several instructions for causing a computer terminal (which may be a personal computer, a server, or a second terminal, a network terminal, and so on) to perform a part of the steps or every step in the respective embodiments provided by the present disclosure.

The same and like parts between the respective embodiments in the specification may be referred to each other. In particular, for terminal embodiments, since they are basically like the method embodiments, the description thereof is relatively simple. For relevant parts, please refer to the description in method embodiments.

In the several embodiments provided by the present disclosure, it should be understood that the disclosed systems and methods may be implemented in other ways. For example, the system embodiments described above are just illustrative. For example, a division of the units is just a logical function division, and there may be other division manners in actual implementation. For example, a plurality of units or components may be combined or integrated into another system, or some features may be ignored or not implemented. Additionally, the coupling or direct coupling or communication connection between each other shown or discussed may be indirect coupling or communication connection through some interfaces, systems or units, and may be in form of electricity, mechanism, or other forms.

Units described as separate components may or may not be physically separated, and components shown as units may or may not be physical units, that is, they may be located in a single location or may be distributed on a plurality of network units. A part of the units or every unit may be selected according to actual needs to realize the purpose of the solution of the embodiment.

In addition, in the respective embodiments of the present disclosure, the respective functional units may be integrated in a single processing unit, or the respective units may physically present alone, or two or more units may be integrated in a single unit.

Although the present disclosure has been described in detail by referring to the drawings and in combination with preferred embodiments, the disclosure is not limited thereto. Without departing from the spirit and substance of the disclosure, those ordinary skilled in the art may make various equivalent modifications or replacements to embodiments of the disclosure, and these modifications or replacements should be within the scope of the disclosure. Within the scope of the technology disclosed by the disclosure, any technician familiar with the technical field may easily think of changes or replacements, which should be covered by the protection scope of the disclosure. Therefore, the protection scope of the disclosure shall be subject to the protection scope of the claims.

1. A method for synchronously recording management information of storage block, comprising:
selecting two blocks, difference between which is the largest, from every good-working block, as a master block and a slave block;
setting a number of pages of an interval at which the master block and the slave block synchronously record; and
synchronously writing management information into the master block and the slave block at the interval of the number of pages.

2. The method according to claim 1, wherein the selecting two blocks, difference between which is the largest, from every good-working block, as a master block and a slave block, comprises:
selecting the good-working blocks from every storage block;
sorting every good-working block by numbers of block;
selecting a top-positioned one of the sorted good-working blocks, as the master block; and
selecting candidate blocks whose parity is different from that of the master block, from the good-working blocks, and selecting a last-numbered one of the candidate blocks, as the slave block.

3. The method according to claim 1, wherein the setting a number of pages of an interval at which the master block and the slave block synchronously record comprises:
setting the number of pages of the interval to be a half of a total number of pages.

4. The method according to claim 3, wherein the synchronously writing management information into the master block and the slave block at the interval of the number of pages, comprises:
in response to writing on a first page of a first half block of the master block, selecting a corresponding page of the slave block according to the number of pages of the interval, and synchronously writing the management information on the corresponding page of a second half block of the slave block;
before synchronously writing the management information into the slave block, writing filling data on every page before the corresponding page of the second half block, for filling; and
in response to writing on a last page of the first half block of the master block, erasing the slave block first by the filling data first, and then synchronously writing the master block and the slave block.

5. The method according to claim 4, further comprising:
finding a last page that is not entirely filled with the filing data, in the master block, reading data as the management information, and outputting the data; and
in response to that finding data in the master block fails, finding a last page that is not entirely filled with the filing data, in the slave block, reading data as the management information, and outputting the data.

6. The method according to claim 5, further comprising:
in response to that a power failure occurs in synchronously recording, and that data in the master block is correct, copying the data in the master block to the corresponding page of the slave block; and
in response to that a power failure occurs in synchronously recording, and that data in the master block is incorrect, respectively drawing previous pages of the master block and the slave block, with respect to the currently-recording pages of the master block and the slave block when the power failure occurs, for proofreading, then removing the data in the master block, and then synchronously copying data in the slave block to the master block.

7-8. (canceled)

9. A terminal, comprising: a memory and one or more processors, wherein computer-readable instructions are stored in the memory, and when the computer-readable instructions are executed by the one or more processors, the one or more processors perform the steps of the method according to claim 1.

10. a nonvolatile computer-readable storage media, storing computer-readable instructions, wherein, when the computer-readable instructions are executed by one or more processors, the one or more processors perform the steps of the method according to claim 1.

11. The method according to claim 1, wherein the parity of a number of the master block is odd, and the parity a number of the slave block is even.

12. The method according to claim 1, wherein the parity of a number of the master block is even, and the parity a number of the slave block is odd.

13. The method according to claim 1, wherein, in response to that the master block records information on a page of a first half block, the slave block records information on a page of a second half block.

14. The method according to claim 1, wherein, in response to that the master block records information on a page of a second half block, the slave block records information on a page of a first half block.

15. The method according to claim 3, wherein information written on page X of the master block=information written on page (X+N/2) of the slave block, where X≤(N/2), and N is the total number of pages.

16. The method according to claim 3, wherein information written on page X of the slave block=information written on page (X−N/2) of the master block, wherein N>X>(N/2), and N is the total number of pages.

17. The method according to claim 3, wherein, in response to that the master block writes page N/2, the slave block writes the last page, that is, page N, wherein N is the total number of pages.

18. The method according to claim 4, wherein the filling data is 1.

19. The method according to claim 4, wherein the filling data is 0.

20. The method according to claim 4, further comprising:
finding a last page that is not entirely filled with the filing data, in the master block, and reading data on the found page of the master block; and
in response to that data on the found page of the master block is correct, outputting the data as the management information.

21. The method according to claim 4, further comprising:
finding a last page that is not entirely filled with the filing data, in the master block, and reading data on the found page of the master block; and
in response to that data on the found page of the master block is incorrect, finding a last page that is not entirely filled with the filing data, in the slave block, reading data on the found page of the slave block, and outputting the data as the management information.

22. The method according to claim 4, further comprising:
finding a last page that is not entirely filled with the filing data, in the master block, and reading data on the found page of the master block; and
in response to that data on the found page of the master block is incorrect, and no data is recorded on the corresponding page in the slave block, reading data on previous pages of the master block and the slave block.
